(19) United States
(12) Patent Application Publication
(10) Pub. No.: US 2023/0391614 A1
(43) Pub. Date: Dec. 7, 2023

(54) INTEGRATION OF NATURAL HYDROGEN RESERVOIR STORAGE CAPACITY OR SUITABLE SUBSURFACE RESERVOIRS WITH OTHER HYDROGEN SOURCES AND SINKS

(71) Applicant: Koloma, Inc., Dublin, OH (US)

(72) Inventor: Peter L. Johnson, Dublin, OH (US)

(21) Appl. No.: 18/206,938

(22) Filed: Jun. 7, 2023

Related U.S. Application Data
(60) Provisional application No. 63/349,892, filed on Jun. 7, 2022.

(51) Int. Cl. C01B 3/00

(52) U.S. Cl. CPC C01B 3/001

(57) ABSTRACT

Embodiments are directed to storing, providing, and using hydrogen, helium, or carbon dioxide within natural hydrogen reservoirs or depleted natural hydrogen reservoirs. A hydrogen storage reservoir can be connected to a hydrogen production system and hydrogen from the hydrogen production system can be injected into the hydrogen storage reservoir. The injected hydrogen can be extracted as needed for energy production, chemical synthesis, or as a feedstock.

### CROSS-REFERENCE TO RELATED APPLICATIONS

This application claims priority to U.S. Provisional Application No. 63/349,892 filed on Jun. 7, 2022, the disclosure of which is incorporated herein in its entirety by this reference.

### TECHNICAL FIELD

Embodiments of the present disclosure relate generally to the field of geology or geophysics. Some embodiments disclose methods of subsurface exploration for natural resources, including hydrogen and carbon dioxide. More particularly, the present disclosure relates to methods for storing, migration, monitoring, and recovery of hydrogen, helium, and carbon dioxide in the subsurface.

This section is intended to introduce various aspects of the technical field, which may be associated with embodiments described in this disclosure. Thus, the forgoing discussion in this section provides a framework for better understanding the disclosure, and is not to be viewed as an admission of prior art.

### SUMMARY

Embodiments are directed to methods of establishing the ability of a reservoir to hold vast amounts of hydrogen (H₂), helium (He), or carbon dioxide (CO₂) in the subsurface and recover it at an economic and efficient rate. This subsurface storage capacity connects the hydrogen, helium, or carbon dioxide demand reservoir to sinks via pipeline, well head, compressors, or other means of transportation that are easily dispatchable from the storage reservoir. In other embodiments the subsurface storage facility integrates that reservoir with surface facilities that produce (e.g., electrolyzer, methanizer, pyrolytic furnace, blast furnace), sequester, or purify (e.g., pressure swing absorption unit, select permeable membrane, cryogenic separation, hydrogen fuel cell) hydrogen, helium, or carbon dioxide.

In an embodiment, a method to provide a gas is disclosed. The method includes connecting a hydrogen storage reservoir to a gas production system. The method includes injecting gas from the gas production system into the hydrogen storage reservoir. The method includes extracting the injected gas from the hydrogen storage reservoir. Extracting the injected gas may occur after the hydrogen storage reservoir is depleted of natural hydrogen. Extracting the injected gas may occur in parallel with depletion of natural hydrogen from the hydrogen storage reservoir.

In an embodiment, a method to provide hydrogen is disclosed. The method includes connecting a hydrogen storage reservoir to a hydrogen production system. The method includes injecting hydrogen from the hydrogen production system into the hydrogen storage reservoir. The method can further include extracting the injected hydrogen as required for energy production, chemical synthesis, or for other means of utilization.

In an embodiment, a system to provide stored gases is disclosed. The system includes a natural hydrogen storage reservoir. The system includes a gas production system. The system includes one or more conduits connecting the natural hydrogen storage reservoir to the gas production system. The gas may include hydrogen and the gas production system may include a hydrogen production system.

In an embodiment, a hydrogen reservoir is disclosed. The hydrogen reservoir includes a porous or permeable subsurface rock and an injection well configured to supply hydrogen gas to the subsurface rock. The hydrogen gas may be stored at or above hydrostatic pressure. The hydrogen reservoir may further include carbon dioxide or helium within the porous subsurface rock. The carbon dioxide or helium may be in a super critical state.

In an embodiment, a method to store carbon dioxide is disclosed. The method includes connecting a carbon dioxide source to a natural hydrogen reservoir, the carbon dioxide source being configured to produce or capture carbon dioxide. The method includes injecting captured carbon dioxide into the natural hydrogen reservoir. The method can further include mineralizing the captured carbon dioxide. The carbon dioxide source may include a reformer such as least one of a steam methane reformer or autothermal reformer.

In an embodiment, a carbon dioxide storage reservoir is disclosed. The carbon dioxide storage reservoir may include a porous or permeable subsurface rock and an injection well configured to inject carbon dioxide gas or supercritical carbon dioxide to the subsurface rock. The carbon dioxide may be stored as supercritical carbon dioxide. The carbon dioxide storage reservoir may include hydrogen or helium within the porous subsurface rock. The hydrogen or helium can be in a super critical state.

In an embodiment, a method to provide helium is disclosed. The method includes connecting a natural gas ((e.g., including hydrogen, helium, CO₂, dihydrogen sulfide (H₂S), or hydrocarbon gases)) well, natural gas storage reservoir (e.g., including hydrogen, helium, CO₂, H₂S, or hydrocarbon gases), or various industrial supplies (e.g., refinery, pipeline, cryogenic purification, membrane purification, or others) of hydrogen, helium, CO₂, H₂S, or hydrocarbon gases to a subsurface hydrogen storage reservoir. The method includes injecting helium or mixtures of helium and other gases into the storage reservoir. The method may include extracting the injected helium for various means of utilization. Extracting the injected helium may occur after the helium storage reservoir is depleted of helium from the storage reservoir. Extracting the injected helium may occur in parallel with depletion of natural hydrogen, helium, natural gas, or CO₂ from the storage reservoir.

In an embodiment, a helium reservoir is disclosed. The helium reservoir includes a porous or permeable subsurface rock and an injection well configured to supply helium to the subsurface rock. The helium may be stored at or above hydrostatic pressure. The helium reservoir may include carbon dioxide, hydrogen, or natural gas within the porous subsurface rock. The helium can be in a super critical state. Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is a block diagram of a system for providing hydrogen, according to an embodiment.

FIG. 2 is a flow diagram of a method for storing and providing one or more gases from a subsurface hydrogen storage reservoir, according to an embodiment.

### DETAILED DESCRIPTION

Embodiments disclosed herein methods of establishing the ability of a reservoir to hold vast amounts of hydrogen (H₂), helium (He), or carbon dioxide (CO₂) below, at, or above hydrostatic pressure, recover it at an economic and efficient rate, connect that reservoir to hydrogen, helium, or carbon dioxide demand sinks via pipeline or other means of transportation, and integrate that reservoir with surface based hydrogen, helium, or carbon dioxide production, sequestration, or purification systems. In other embodiments, disclosed herein methods of establishing the ability of a reservoir to hold vast amounts of hydrogen, helium, or carbon dioxide below, at, or above hydrostatic pressure, recover it at an economic and efficient rate, connect that reservoir to hydrogen, helium, or carbon dioxide supplies at the surface via pipeline or other means of transportation for storage.

There are efforts to explore and develop new salt cavern capacity for underground hydrogen or helium storage. Salt, because of its close packing structure and low porosity, along with self-healing following deformation events, can hold nearly all gases at high pressure. However, salt caverns are relatively small on average. For example, most salt caverns are sized to be able to store approximately 6,000-10,000 tonnes of hydrogen. If used at peak storage capacity, where 80% of the gas in the cavern is exhausted and refilled every day, a 6,000 tonne cavern could only support approximately 1.75 million tonnes per year of intermittent production. Above ground storage for hydrogen or liquification and storage comes at a very high price that makes these strategies unfeasible for most commercial applications. unfeasible for most commercial applications.

Underground hydrogen storage is thought to be critical to create redundancy in a developing hydrogen economy but also serves the purpose of compensating for the potential irregularity of hydrogen production via renewable energy-driven electrolysis, where the hydrogen production profile might follow wind, solar, or even hydroelectric production profiles in order to achieve the lowest cost of production. Electrolyzed hydrogen producers are generally faced with a challenge: build near the point of production with lowest cost renewables (e.g., desert locations in the southwestern United States for solar, high wind locations like the Great Plains or west Texas for wind, or the Pacific Northwest United States for hydroelectric power) and produce intermittent hydrogen that is not located proximal to a demand sink, or locate electrolyzers near or “over the fence” from a demand sink (offtaker) and pay significant grid charges, wire charges, and Renewable Energy Certificates (RECs) to achieve a flatter production profile near the user. Producers could also build on site buffer storage, but this is widely viewed to be cost prohibitive. “Green” hydrogen producers are stuck between option 1 (low cost, intermittent, and far from and unconnected to demand) and option 2 (high cost, grid connected with synthetic base load, and over the fence).

Another form of clean hydrogen is natural gas-derived hydrogen from steam methane reforming or autothermal reforming with carbon capture and sequestration on the back end. This also provides geographic and supply chain challenges to a production company, in that locating a “Blue” hydrogen production facility near a demand sink might locate it far away from a geologic CO₂ sink and create transportation challenges for the CO₂, whereas location near a CO₂ storage reservoir may place hydrogen far from the demand sink/offtake. A particularly desirable location for a greenfield blue hydrogen facility would either be on top of a CO₂ sequestration resource with hydrogen production that is connected via pipelines to demand sinks, or over the fence from a hydrogen demand sink and pipeline connected to a CO₂ sequestration resource. There are not many options that satisfy both of these conditions.

Natural hydrogen reservoirs (or other suitable subsurface reservoirs), if they are initially developed because a large supply of naturally trapped hydrogen was discovered, can include a pressure-bearing and sealing capability proven via hundreds of thousands and millions of years of geologic demonstration. The natural hydrogen present in the reservoir can be coupled to a pipeline system where it can be delivered to downstream customers or enabled for storage from top side producers. Generally, the storage capacity in the natural hydrogen reservoirs (or other suitable subsurface reservoirs) can be approximately 1 million tonnes or more. When discharged, it could enable more than one billion tonnes per year of intermittent production. Natural hydrogen reservoirs (or other suitable subsurface reservoirs) tied to electrolyzers or other means of hydrogen production can supply hydrogen (H₂) and operate continuously when connected to demand sinks because of the storage capacity.

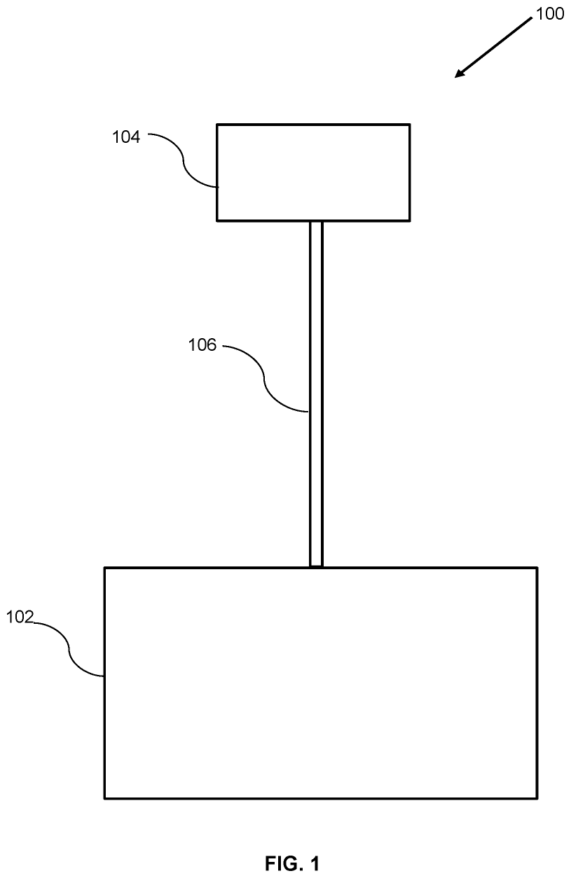

In some embodiments, a system for storing hydrogen may be utilized to perform the methods disclosed herein. FIG. 1 is a block diagram of a system 100 for providing hydrogen, helium, or carbon dioxide gas(es) or other forms of fluid(s), according to an embodiment. The system 100 includes a hydrogen storage reservoir 102, a gas or other forms of fluid(s) production system 104, and one or more conduits 106 connecting the hydrogen storage reservoir 102 to the gas or other forms of fluid(s) production system 104.

The hydrogen storage reservoir 102 may include a subsurface hydrogen storage reservoir, such as a natural hydrogen reservoir (e.g., a subsurface reservoir containing natural hydrogen). In some embodiments, the hydrogen storage reservoir 102 may include a carbon dioxide or other subsurface gas reservoir that is able to retain hydrogen and other gases without leaking those gases therefrom. The hydrogen storage reservoir may be an at least partially depleted subsurface gas reservoir, such as a depleted natural hydrogen reservoir. The hydrogen storage reservoir may not be a salt cave (e.g., manmade or natural salt cave). The relatively larger size of natural subsurface hydrogen reservoirs compared to salt caves provides a relatively larger storage capacity with proven hydrogen retention capabilities. Accordingly, the subsurface hydrogen storage reservoir may be sized to contain at least 15,000 tonnes of hydrogen (e.g., 179 million m 3 of hydrogen in gaseous form), such as 15,000 tonnes to 3,000,000 tonnes, 50,000 tonnes to 1,500,000 tonnes, 20,000 tonnes to 100,000 tonnes, less than 2,000,000 tonnes, or less than 200,000 tonnes of hydrogen.

The hydrogen storage reservoir 102 may contain more gases than hydrogen alone, such as carbon dioxide, helium, natural gas, oxygen, nitrogen, any other gas, or combinations of any of the foregoing.

The gas production system 104 may include one or more of a hydrogen production system, a carbon dioxide production or capturing system, or a helium production or separation system. In embodiments, a hydrogen production system may include one or more of a reformer system (e.g., SMR, ATR, or the like), an electrolysis system, a pyrolysis system, a plasma reformer, or any other suitable hydrogen production system. The gas production system 104 may include multiple hydrogen production systems or include carbon dioxide addition for synthetic fuels production.

The one or more conduits 106 may include one or more of wells, pipelines, pipes, or the like. The one or more conduits 106 may include an injection well for injecting one or more gases (e.g., hydrogen, helium, carbon dioxide) into the hydrogen storage reservoir 102 and a production well for extracting the one or more gases from the hydrogen storage reservoir 102. The system 100 may include one or more pumps to inject hydrogen or any other gas into the hydrogen storage reservoir 102. The one or more pumps may be connected to the one or more conduits 106.

The system 100 may be connected to one or more hydrogen demand sinks. For example, the system 100 may be fluidly connected to a hydrogen-fired power plant, a hydrogen distribution hub (e.g., hydrogen pump for vehicles), an ammonia factory, a synthetic fuels refinery, a cement factory, ethanol refinery, truck refueling stations, clean aviation fuels refinery, or direct reduced iron manufacturing facility, a data center, or the like. The system 100 may be connected to a demand sink via one or more pipelines.

In some embodiments, a system 100 may not include the gas production system 104. In such examples, the system may include a natural hydrogen storage reservoir containing gases that are not natural to the reservoir (e.g., gases that were not originally stored in the hydrogen storage reservoir), such as externally obtained or produced hydrogen, carbon dioxide, or helium.

In some embodiments, a system 100 may not include the extraction well, extraction wells, or an extraction system. For example, the system 100 may include a natural hydrogen storage reservoir and an injection well. In such embodiments, the system 100 may be used to permanently store or sequester one or more gases in the natural hydrogen storage reservoir. For example, the injection well may be utilized to inject carbon dioxide, dihydrogen sulfide, or other fluids into the natural hydrogen storage reservoir for mineralization within the porous subsurface rock therein. The injection well may be configured to supply one or more of hydrogen gas, helium, or carbon dioxide gas (or fluids) to the porous subsurface rock, wherein the hydrogen gas is stored at or above hydrostatic pressure. In some examples, a gas (e.g., carbon dioxide) may be injected and stored in the porous subsurface rock, wherein the gas (e.g., carbon dioxide) is a super critical fluid. The porous subsurface rock of the hydrogen storage reservoir and the injection well may form a hydrogen storage reservoir. The natural hydrogen storage reservoir may store the “non-natural” gas(es) therein, such as hydrogen that is produced, collected, separated, or otherwise obtained from surface operations. The non-natural gas(es) (e.g., electrolysis produced hydrogen) can be differentiated from natural gases (e.g., natural hydrogen) by isotopic characteristics. Of course, the stored, mineralized, or super critical gases stored in the natural hydrogen storage reservoir may be extracted later through an extraction or production well fluidly connected thereto.

Any of the systems disclosed herein may be utilized to store and extract fluids from a subsurface hydrogen reservoir. For example, the system 100 may be utilized to perform one or more portions of any of the methods disclosed herein.

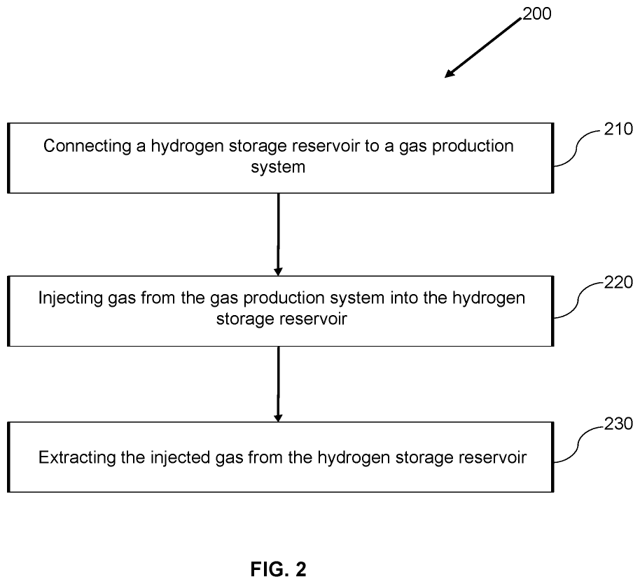

FIG. 2 is a flow diagram of a method 200 for storing and providing one or more gases from a subsurface hydrogen storage reservoir, according to an embodiment. The method 200 includes the act 210 of connecting a hydrogen storage reservoir to a gas production system; an act 220 of injecting gas from the gas production system into the hydrogen storage reservoir; and an act 230 of extracting the injected gas from the hydrogen storage reservoir. In some embodiments, the method 200 may include more or fewer acts than the acts 210-230. One or more of the acts 210-230 may be omitted, combined, or split. For example, the act 210 or 230 may be omitted in some embodiments. Additional acts may be performed as part of the method 200.

The act 210 of connecting a hydrogen storage reservoir to a gas production system may include connecting a hydrogen storage reservoir to a gas production system, such as connecting the hydrogen storage reservoir to a hydrogen production system, a carbon dioxide production or capture system (e.g., a reformer), a helium production or capture system, or the like. For example, methods of providing hydrogen gas, helium, or carbon dioxide can include connecting a (natural) hydrogen or other gas storage reservoir to a hydrogen production system (e.g., electrolyzer), pipeline, or purification system (e.g., pressure swing absorption, selective permeable membrane, cryogenic separation system, or fuel cell).

Connecting a hydrogen storage reservoir to a gas (e.g., hydrogen) production system may include making a fluid connection between the gas production system and the hydrogen storage reservoir with one or more of a well, a pipeline, or a pump. In some embodiments, the connection can include a pipeline system, injection well, or extraction well configured to accommodate hydrogen gas pressures and other related properties. The connection can include any suitable means of hydrogen, helium, or carbon dioxide transportation to bring hydrogen, helium, or carbon dioxide from the natural storage reservoir to the surface for various forms of utilization (e.g., ammonia generation, desulfurization of hydrocarbons, synthetic fuels, direct reduced iron steel manufacturing). In some embodiments, the various forms of hydrogen, helium, or carbon dioxide production (e.g., electrolysis by wind, solar, hydropower, or others; reforming), sequestration, or purification (e.g., pressure swing absorption, selective permeable membrane, cryogenic separation system, or fuel cell) systems can be connected to the natural storage reservoir for later utilization. For example, connecting a hydrogen storage reservoir to a gas production system may include connecting the hydrogen storage reservoir to an output of one or more of an electrolysis system, a pyrolysis system, or a reformer system configured to produce hydrogen. The conduits or pipeline coupled to the output of the gas production system can be connected to injection and/or production wells at the hydrogen storage reservoir.

The (subsurface natural) hydrogen storage reservoir (102 of FIG. 1) can include a porous subsurface rock. The porous hydrogen storage reservoir may have an injection well fluidly connected thereto to supply hydrogen (H₂ gas) to the porous subsurface rock. The hydrogen storage reservoir may include a subsurface geological formation that is at least partially depleted of natural hydrogen gas. The hydrogen storage reservoir can be sized to hold vast amounts of hydrogen gas, carbon dioxide, helium, or other gases, such as at least 15,000 tonnes of hydrogen (e.g., 179 million m³ of hydrogen in gaseous form), such as 15,000 tonnes to 3,000,000 tonnes, 50,000 tonnes to 1,500,000 tonnes, 20,000 tonnes to 100,000 tonnes, less than 2,000,000 tonnes, or less than 200,000 tonnes of hydrogen.

By connecting renewable powered electrolyzers (or other forms of hydrogen generation) to a large, geologically proven natural hydrogen reservoir (or other suitable subsurface reservoirs), the electrolysis (or other form of hydrogen generation) plant owner is able to overcome their major supply challenges of intermittency and paying high cost for grid connected power to be near the demand sinks. Because the scale of electrolyzers is typically smaller compared to other production methods, ordinarily it would be challenging economically to connect them via pipeline to demand sinks, but by pairing them with large natural hydrogen reservoirs (or other suitable subsurface reservoirs), connectivity of the system would be much easier to justify economically.

The act 220 of injecting gas from the gas production system into the hydrogen storage reservoir may include one or more of injecting hydrogen from the hydrogen production system into the hydrogen storage reservoir, injecting helium from a helium production or separation system into the hydrogen storage reservoir, or injecting carbon dioxide from a carbon dioxide capture or production system into the hydrogen storage reservoir. Injecting gas from the gas production system into the hydrogen storage reservoir may include injecting gas into the hydrogen storage reservoir via an injection well.

For example, injecting gas from the gas production system into the hydrogen storage reservoir may include injecting hydrogen from one or more of an electrolysis system, a pyrolysis system, or a reformer system configured to produce hydrogen, into the hydrogen storage reservoir.

Providing hydrogen can further include injecting hydrogen from the hydrogen production system into the hydrogen storage reservoir (e.g., new or depleted natural hydrogen reservoir) and then extracting the injected hydrogen as required for energy production. In some embodiments, the stability and redundancy of a new or depleted natural hydrogen reservoir (or other suitable subsurface reservoirs), proven as a resource that can store hydrogen, helium, or carbon dioxide at high pressures, would also allow for long term top side hydrogen conversion infrastructure, like an ammonia plant, synthetic fuels plant, or the like, to be built with an anticipated lifetime much longer than the hydrogen supply in the reservoir itself as it can be repurposed as a storage resource for other means of intermittent hydrogen production. In some embodiments, when the conversion infrastructure includes electrolyzers, the oxygen from the electrolyzer could be used as a feedstock for autothermal reformers or as an oxidant for any fired processes like power production, compressors, pumps, or other equipment. Heat from the electrolyzer could also be used to augment steam production in a power plant or steam production for downhole injection. The natural hydrogen reservoir (or other suitable subsurface reservoirs) may be utilized as a hydrogen hub, synthetic fuels hub, and the center of a hydrogen ecosystem that will allow for full use of all byproducts from the electrolysis process or other hydrogen production processes.

The act 230 of extracting the injected gas from the hydrogen storage reservoir may include extracting one or more of hydrogen, carbon dioxide, or helium from the hydrogen storage reservoir. For example, extracting the injected gas from the hydrogen storage reservoir may include extracting the injected hydrogen for energy production, chemical synthesis, or the like. In some embodiments, extracting the injected gas may be carried out after the hydrogen storage reservoir is depleted of natural species of gases (e.g., natural hydrogen, methane, helium, carbon dioxide) from the hydrogen storage reservoir. For example, extracting injected hydrogen may occur after the hydrogen storage reservoir is depleted of natural hydrogen. In some embodiments, extracting the injected gas may be carried out in parallel with depletion of natural species of gases (e.g., natural hydrogen) from the hydrogen storage reservoir.

The method 200 may include supplying the extracted gas, such as hydrogen, helium, or carbon dioxide to a user. For example, supplying extracted hydrogen to a user may include supplying the extracted hydrogen to one or more of an energy producer or a chemical producer, through a pipeline. The energy producer may include one or more oxidizing units configured to use hydrogen as a fuel. The chemical producer may include one or more synthesis systems configured to use hydrogen, carbon dioxide, or the like as a feedstock for synthesizing one or more chemicals. For example, the chemical producer may include a fuel production system configured to synthesize alkane fuels using the extracted hydrogen.

The method 200 may include storing the injected gas in the hydrogen storage reservoir for a selected duration. In some embodiments, the hydrogen gas is stored at or above hydrostatic pressure. The duration may be days, weeks, months, or years.

In some embodiments, the hydrogen storage reservoir can include carbon dioxide (CO₂) or helium within the porous subsurface rock. The helium or carbon dioxide can be supercritical. Helium or carbon dioxide, or mixtures thereof can be utilized to create pressure support and reduce viscosity of oil reservoirs, in a technique known as Enhanced Oil Recovery, or EOR. For “Blue hydrogen” prospective producers, carbon dioxide storage resources, be it a saline aquifer, a depleted oil or gas reservoir, or an EOR resource, are generally not connected via carbon dioxide pipeline to a hydrogen demand sink. This is resolved by building sufficient top side infrastructure that hydrogen or carbon dioxide can be converted into more easily transportable liquid products like ammonia or synthetic fuel top side above a carbon dioxide storage resource with natural gas connectivity. In some embodiments, large pipeline networks carrying either hydrogen, helium, or carbon dioxide may be less necessary. However, a proven natural hydrogen storage reservoir (or other suitable subsurface reservoirs) as set forth herein can address the challenge.

The pore space in a natural hydrogen storage reservoir (or other suitable subsurface reservoirs) can be used to store carbon dioxide, such as from a “Blue” hydrogen production facility built adjacent to or on top of the natural hydrogen reservoir (or other suitable subsurface reservoirs). The carbon dioxide can be used to provide pressure support to increase recovery of the natural hydrogen in the reservoir and the depleted reservoir could serve as a storage resource for the CO₂. Because the natural hydrogen reservoir can include a pipeline connected to demand sinks (e.g., an injection and/or production well), the challenge of connecting carbon dioxide storage resources and hydrogen demand is resolved. As hydrogen is removed from a natural hydrogen reservoir, pore space can be freed to store injected carbon dioxide. When the carbon dioxide is injected to the right depth, the carbon dioxide would be super critical and would be considerably denser than any remaining hydrogen which is present at the top of a dome or trap within the natural hydrogen storage reservoir. The freed-up pore space volume, the geologically demonstrated sealing and closure capability of the natural hydrogen reservoir system (or other suitable subsurface reservoir systems) and the use of the carbon dioxide to provide pressure support to the hydrogen provides a method to store carbon dioxide that can be beneficial.

In some embodiments, storing carbon dioxide can include connecting a reformer to a natural hydrogen reservoir. The reformer can be configured to capture carbon dioxide. In some embodiments, the reformer can include at least one of a steam methane reformer, autothermal reformer, or the like. The reformer can be connected via a pipeline shared with the natural hydrogen storage reservoir (or other suitable subsurface reservoirs) to downstream hydrogen demand and also configured to capture carbon dioxide from the process. Storing carbon dioxide can also include injecting captured carbon dioxide into the natural hydrogen storage reservoir. In some embodiments, the carbon dioxide can be injected via an injection well where it is stored in vacant pore space within the natural hydrogen storage reservoir and may provide pressure support to further hydrogen recovery.

In some examples, the method 200 may not include extracting the injected gas from the hydrogen storage reservoir. For example, the method 200 may include mineralizing CO₂ or another chemical into porous subsurface rock within the subsurface hydrogen storage reservoir. For example, the captured carbon dioxide can be injected into the natural hydrogen storage reservoir (and underlying source rock) where it can be mineralized. Most natural hydrogen reservoirs are above or near source rock that could serve as carbon dioxide sinks through carbon dioxide mineralization. Such mineralization further increases the carbon dioxide storage capacity in the natural hydrogen reservoir that may be connected via pipeline to hydrogen demand sinks. In some cases, one injection well bore could be used to deliver carbon dioxide to depleted pore space and also to source rock volume where it could be stored via both sequestration and mineralization.

In some embodiments, methane separated from the natural hydrogen gas in a natural hydrogen reservoir may be utilized as part or all of the feedstock for at least one of a SMR or an autothermal reformer (ATR) system. Oxygen and heat from electrolyzers tied into the same hydrogen storage reservoir (or other suitable subsurface reservoirs) may be utilized to enhance the economics (e.g., the efficiency) of the SMR or ATR system.

In some examples, the method 200 may not include connecting a hydrogen storage reservoir to a gas production system. In such examples, the method may only include one or more of injecting, storing, or extracting the gas(es) in or from the hydrogen storage reservoir. For example, the method 200 may include injecting a gas from a gas production system into a hydrogen storage reservoir including a subsurface geological formation that has been at least partially depleted of natural hydrogen, and extracting the injected gas for later use. The later use may include energy production, chemical synthesis, or as another feedstock. Specific embodiments may include injecting hydrogen from a hydrogen production system into a hydrogen storage reservoir including a subsurface geological formation that has been depleted of natural hydrogen, and extracting the injected hydrogen for energy production, chemical synthesis, or as another feedstock.

In some embodiments, the method 200 may be adapted to sequester carbon dioxide in a natural hydrogen storage reservoir. In such embodiments, the method may include connecting a carbon dioxide production or capture system such as a reformer to a natural hydrogen storage reservoir, the reformer configured to capture carbon dioxide; injecting captured carbon dioxide into the natural hydrogen reservoir; and mineralizing the captured carbon dioxide within the natural hydrogen reservoir. The reformer may include a steam methane reformer or an autothermal reformer. Mineralizing the captured carbon dioxide may include carrying out one or more chemical reactions of carbon dioxide and a rock matrix within the rock matrix, such as one or more decarbonation reactions as set forth in Table 1 below.

TABLE 1
Decarbonation Reactions

| | | | Moles | |
|---|---|---|---|---|
| | | | of | |
| | Mineral | | Igneous | Moles of CO₂ |
| Mineral | Phase | Reaction | Mtrls | Sequestered |
| Olivine | Forsterite | ${Mg}_{2} {SiO}_{4} + 2 {CO}_{2} {\to }^{yields} 2 {MgCO}_{3} + {SiO}_{2}$ | 1 | 2 |
| Pyroxene | Enstatite | ${Mg}_{2} {Si}_{2} {O}_{6} + 2 {CO}_{2} {\to }^{yields} {Mg}_{3} {CO}_{3} + 2 {SiO}_{2}$ | 1 | 2 |
| Plagioclase | Anorthite | ${CaAl}_{2} {Si}_{2} {O}_{8} + 2 {H}_{2} O {\to }^{yields} {CaCO}_{3} + {Al}_{2} {Si}_{2} {{O}_{5} ( OH )}_{4}$ | 1 | 1 |
| Serpentine | Anorthite | ${Mg}_{3} {Si}_{2} {{O}_{5} ( OH )}_{4} + 3 {CO}_{2} {\to }^{yields} 3 {MgCO}_{3} + 2 {SiO}_{2} + 2 {H}_{2} O$ | 1 | 3 |
| Brucite | Enstatite | ${Mg ( OH )}_{2} + {CO}_{2} {\to }^{yields} {MgCO}_{3} + 2 {H}_{2} O$ | 1 | 1 |

Suitable mineralization reactions are described in U.S. patent application Ser. No. 18/133,889 filed on 12 Apr. 2023, the disclosure of which is incorporated herein, in its entirety, by this reference.

Although the present specification focuses on hydrogen, helium, and carbon dioxide, it is understood that the techniques disclosed herein are not so limited and can find application in the identification, quantitative assessment, or storage of other subsurface materials, including other gases, minerals, and gems, as well as materials found in large structures such as foundations, dams, hydroelectric facilities, and nuclear facilities to name a few.

In the production of natural resources from formations within the earth, a well or borehole is drilled into the earth to the location where the natural resource is believed to be located. Similarly in the sequestration of greenhouse gases in formations within the earth, a well or borehole is drilled into the earth to the location where the greenhouse gas will be injected, located, and sequestered. These natural resources may be hydrogen; helium; carbon dioxide; methane or other hydrocarbon gases; a dihydrogen sulfide; a hydrogen reservoir; a helium reservoir; a carbon dioxide reservoir; a reservoir rich in dihydrogen sulfide; a reservoir rich in hydrocarbons; the natural resource may be fresh water; brackish water; brine; it may be a heat source for geothermal energy; or it may be some other natural resource, ore deposit, mineral, metal, or gem that is located within the ground.

These resource-containing formations may be a few hundred feet, a few thousand feet, or tens of thousands of feet below the surface of the earth, including under the floor of a body of water, e.g., below the seafloor or beneath other natural resources, e.g., below aquifers. In addition to being at various depths within the earth, these formations may cover areas of differing sizes, shapes, and volumes.

Typically, and by way of general illustration, in drilling a well an initial borehole is made into the earth (e.g., the surface of land or seabed) and then subsequent and smaller diameter boreholes are drilled to extend the overall depth of the borehole. In this manner as the overall borehole gets deeper its diameter becomes smaller; resulting in what can be envisioned as a telescoping assembly of holes with the largest diameter hole being at the top of the borehole closest to the surface of the earth.

Thus, by way of example, the starting phases of a subsea drill process may be explained in general as follows. Once the drilling rig is positioned on the surface of the water over the area where drilling is to take place, an initial borehole is made by drilling a 36″ hole in the earth to a depth of about 200-300 ft. below the seafloor. A 30″ casing is inserted into this initial borehole. This 30″ casing may also be called a conductor. The 30″ conductor may or may not be cemented into place. During this drilling operation a riser is generally not used and the cuttings from the borehole, e.g., the earth and other material removed from the borehole by the drilling activity are returned to the seafloor. Next, a 26″ diameter borehole is drilled within the 30″ casing, extending the depth of the borehole to about 1,000-1,500 ft. This drilling operation may also be conducted without using a riser. A 20″ casing is then inserted into the 30″ conductor and 26″ borehole. This 20″ casing is cemented into place. The 20″ casing has a wellhead secured to it. (In other operations an additional smaller diameter borehole may be drilled, and a smaller diameter casing inserted into that borehole with the wellhead being secured to that smaller diameter casing.) A blow out preventer (BOP) is then secured to a riser and lowered by the riser to the seafloor; where the BOP is secured to the wellhead. From this point forward all drilling activity in the borehole takes place through the riser and the BOP.

It should be noted that riserless subsea drilling operations are also contemplated.

For a land-based drill process, the steps are similar, although the large diameter tubulars, 30″-20″ are typically not used. Thus, and generally, there is a surface casing that is typically about 13⅜″ diameter. This may extend from the surface (e.g., wellhead and BOP) to depths of tens of feet to hundreds of feet. One of the purposes of the surface casing is to meet environmental concerns in protecting ground water and prevent surface casing ventflow of greenhouse gases or flammable gases. The surface casing should have a sufficiently large diameter to allow the drill string, production equipment such as electronic submersible pumps (ESPs) and circulation mud to pass through. Below the casing one or more different diameter intermediate casings may be used. (It is understood that sections of a borehole may not be cased, which sections are referred to as open hole.) These can have diameters in the range of about 9″ to about 7,″ although larger and smaller sizes may be used, and can extend to depths of thousands and tens of thousands of feet. The section of the well located within the reservoir, e.g., the section of the formation containing the natural resources, can be called the pay zone. Inside of the casing and extending from a pay zone, or production zone of the borehole up to and through the wellhead on the surface is the production tubing. There may be a single production tubing or multiple production tubings in a single borehole, with each of the production tubing endings being at different depths.

Fluid communication between the formation and the well can be greatly increased by the use of hydraulic fracturing techniques. The first uses of hydraulic fracturing date back to the late 1940s and early 1950s. In general, hydraulic fracturing treatments involve forcing fluids down the well and into the formation, where the fluids enter the formation and crack, e.g., force the layers of rock to break apart or fracture. These fractures create channels or flow paths that may have cross sections of a few microns, to a few millimeters, to several millimeters in size, and potentially larger. The fractures may also extend out from the well in all directions for a few feet, several feet, and tens of feet or further. The fractures may be kept open by using a proppant (e.g., various sized sand grains) that is forced down the well with the fracturing fluid in a single operation. It should be remembered that the longitudinal axis of the well in the reservoir may not be vertical: it may be on an angle (either sloping up or down) or it may be horizontal.

As used herein, unless specified otherwise, the terms “hydrogen exploration and production,” “carbon dioxide exploration and production,” “helium exploration and production,” “dihydrogen sulfide exploration and production,” “exploration and production activities,” “E&P,” “E&P activities,” and similar such terms are to be given their broadest possible meaning, and include surveying, geological analysis, well planning, reservoir planning, reservoir management, drilling a well, workover and completion activities, hydrogen, helium, or carbon dioxide production, flowing of hydrogen, helium, or carbon dioxide from a well, collection of hydrogen, helium, or carbon dioxide secondary and tertiary recovery of various fluids from a well, the management of flowing hydrogen, helium, or carbon dioxide from a well, and any other upstream activities.

As used herein, unless specified otherwise, the term “earth” should be given its broadest possible meaning, and includes, the ground, all natural materials, such as rocks, and artificial materials, such as concrete, that are or may be found in the ground.

As used herein, unless specified otherwise “offshore” and “offshore drilling activities” and similar such terms are used in their broadest sense and would include drilling activities on, or in, any body of water, whether fresh or salt water, whether manmade or naturally occurring, such as for example rivers, lakes, canals, inland seas, oceans, seas, such as the North Sea, bays and gulfs, such as the Gulf of Mexico. As used herein, unless specified otherwise the term “offshore drilling rig” is to be given its broadest possible meaning and would include fixed towers, tenders, platforms, barges, jack-ups, floating platforms, drill ships, dynamically positioned drill ships, semi-submersibles, and dynamically positioned semi-submersibles. As used herein, unless specified otherwise the term “seafloor” is to be given its broadest possible meaning and would include any surface of the earth that lies under, or is at the bottom of, any body of water, whether fresh or salt water, whether manmade or naturally occurring.

As used herein, unless specified otherwise, the term “borehole” should be given its broadest possible meaning and includes any opening that is created in the earth that is substantially longer than it is wide, such as a well, a well bore, a well hole, a micro hole, a slimhole, and other terms commonly used or known in the arts to define these types of narrow long passages. Wells would further include exploratory, discovery, production, abandoned, reentered, reworked, recirculation, and injection wells. They would include both cased and uncased wells, and sections of those wells. Uncased wells, or section of wells, also are called open holes, boreholes, open boreholes, open bores, or open hole sections. Boreholes may further have segments or sections that have different orientations, they may have straight sections and arcuate sections and combinations thereof. Thus, as used herein unless expressly provided otherwise, the “bottom” of a borehole, the “bottom surface” of the borehole and similar terms refer to the end of the borehole, e.g., that portion of the borehole furthest along the path of the borehole from the borehole's opening, the surface of the earth, or the borehole's beginning. The terms “side” and “wall” of a borehole should be given their broadest possible meaning and include the longitudinal surfaces of the borehole, whether or not casing or a liner is present, as such, these terms would include the sides of an open borehole or the sides of the casing that has been positioned within a borehole. Boreholes may be made up of a single passage, multiple passages, connected passages, (e.g., branched configuration, fishboned configuration, duallateral configuration, trilateral configuration, quadrilateral configuration, pitchfork configuration, pinnate configuration, or comb configuration), and combinations and variations thereof.

Boreholes are generally formed and advanced by using mechanical drilling equipment having a rotating drilling tool (e.g., a bit). For example, and in general, when creating a borehole in the earth, a drilling bit extends to and into the earth and is rotated to create a hole in the earth. To perform the drilling operation, the bit must be forced against the material to be removed with a sufficient force to exceed the shear strength, compressive strength, or combinations thereof, of that material. The material that is cut from the earth is generally known as cuttings or drill cuttings (e.g., waste), which may be chips of rock, dust, rock fibers, and other types of materials and structures that may be created by the bit's interactions with the earth. These cuttings are typically removed from the borehole by the use of fluids, which fluids can be liquids, foams or gases, or other materials known to the art.

As used herein, unless specified otherwise, the term “drill pipe” is to be given its broadest possible meaning and includes all forms of pipe used for drilling activities; and refers to a single section or piece of pipe. As used herein the terms “stand of drill pipe,” “drill pipe stand,” “stand of pipe,” “stand”, and similar type terms should be given their broadest possible meaning and include two, three, or four sections of drill pipe that have been connected (e.g., joined together) typically by joints having threaded connections. As used herein the terms “drill string,” “string,” “string of drill pipe,” string of pipe”, and similar type terms should be given their broadest definition and would include a stand or stands joined together for the purpose of being employed in a borehole. Thus, a drill string could include many stands and many hundreds of sections of drill pipe.

As used herein, unless specified otherwise, the terms “formation,” “reservoir,” “pay zone,” and similar terms, are to be given their broadest possible meanings and would include all locations, areas, and geological features within the earth that contain, may contain, or are believed to contain, hydrogen, carbon dioxide, helium, or dihydrogen sulfide.

As used herein, unless specified otherwise, the terms “field,” “oil field,” “gas field”, and similar terms, are to be given their broadest possible meanings, and would include any area of land, seafloor, or water that is loosely or directly associated with a geologic formation, and more particularly with a resource containing formation, thus, a field may have one or more exploratory and producing wells associated with it, a field may have one or more governmental body or private resource leases associated with it, and one or more field(s) may be directly associated with a resource containing formation.

As used herein, unless specified otherwise, the terms “conventional hydrogen,” “conventional carbon dioxide,” “conventional helium,” “conventional dihydrogen sulfide,” “conventional natural gas,” “conventional,” “conventional production,” and similar such terms are to be given their broadest possible meaning and include hydrogen, carbon dioxide, helium, or dihydrogen sulfide that are trapped in structures or other trapping mechanisms in the earth. Generally, in these conventional formations the hydrogen, carbon dioxide, helium, dihydrogen sulfide, or natural gas have migrated in permeable, or semi-permeable formations to a trap, or area where they are accumulated. Typically, in conventional formations a non-porous, relatively impermeable layer is above, or encompassing the area of accumulated hydrogen, carbon dioxide, helium, dihydrogen sulfide, or natural gas, in essence trapping the hydrogen, carbon dioxide, helium, dihydrogen sulfide, or natural gas in the accumulation. Conventional reservoirs have been historically the sources of the vast majority of natural gas, hydrogen, carbon dioxide, helium, and dihydrogen sulfide observed. As used herein, unless specified otherwise, the terms “unconventional hydrogen,” “unconventional carbon dioxide,” “unconventional helium,” “unconventional dihydrogen sulfide,” “unconventional natural gas,” “unconventional,” “unconventional production,” and similar such terms are to be given their broadest possible meaning and includes hydrogen, carbon dioxide, helium, dihydrogen sulfide, or natural gas that are held in impermeable rock, and which have not migrated to traps or areas of accumulation.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

Generally, the term “about” as used herein unless stated otherwise is meant to encompass a variance or range of ±10%, the experimental or instrument error associated with obtaining the stated value, and preferably the larger of these.

As used herein, unless stated otherwise, room temperature is 25° C. And, standard temperature and pressure is 25° C. and 1 atmosphere.

The term “CO₂e” is used to define carbon dioxide equivalence of other, more potent greenhouse gases, to carbon dioxide (e.g., methane) on a global warming potential basis of 100 years, based on IPCC AR5 methodology. The term “carbon intensity” is taken to mean the lifecycle CO₂ₑ generated per unit mass of a product.

CO₂ is widely recognized as a greenhouse gas (GHG), and the continued accumulation of CO₂ and other GHGs in the atmosphere is expected to cause problematic changes to global ecosystems and contribute to myriad other problems, such as ocean acidification and sea level rise. The two primary causes of carbon emissions globally are the use of fossil fuels for power generation and transportation.

Given the risks of CO₂ emissions, significant work has gone into finding replacements to existing high carbon energy sources, or ways to decarbonize existing energy sources. However, many of these low carbon alternatives have been uneconomic or not dispatchable enough to replace the current options.

In power generation, the alternatives to the highly reliable, low cost, but high emission sources (gas and coal) are either dispatchable and expensive (e.g., nuclear, hydroelectric, green hydrogen, or blue hydrogen), or inexpensive and intermittent (e.g., solar and wind, green hydrogen in some cases). There is only one existing source that is both lower cost and dispatchable, and that is geothermal. However, geothermal resources are limited, many of the economically productive geothermal resources have already been developed and are nearing end of life, and many geothermal resources are already in decline. As such, the growth outlook for geothermal is limited without significant technical advances.

Green hydrogen (hydrogen produced from water without the utilization of fossil fuels), which is generated by electrolysis powered from either solar, wind, hydroelectric, or geothermal energy can be a reliable source of low carbon energy when coupled with storage, but high capital cost, intermittent production due to intermittent energy sources or high cost of energy when grid connected, and the high cost and low availability of suitable hydrogen storage resources limits applicability. In addition, electrolysis consumes significantly more energy to produce hydrogen than what is stored in the hydrogen, resulting in a low round trip efficiency in the system.

Blue hydrogen faces a similar set of problems to green hydrogen: it takes a low cost, high emission fuel source like coal or natural gas, and by adding expensive and parasitic carbon capture facilities, converts this low-cost-high-emission source of energy into a high-cost-low-emission source. Thus, even though large volumes of hydrogen can be formed in processes that subsequently prevent greenhouse gas emissions from reaching the atmosphere, the newly developed hydrogen resource is not cost competitive with other forms of energy derived from fossil fuels. Additionally, the challenges around finding carbon sequestration resources that can be used to permanently store the captured carbon from these processes result in limited opportunities to deploy these technologies today.

Natural hydrogen (or “gold hydrogen”), produced from the subsurface by drilling and producing wells can provide an abundant source of low emission, low cost, fully dispatchable energy. Existing natural hydrogen reservoirs may constitute a volumetric and reliable source of subsurface hydrogen storage and easily dispatchable hydrogen supply.

Each of these energy sources and their inherent advantages and limitations are also relevant to transportation. When considering transportation fuels, by far the major sources of fuel are diesel and gasoline, both derived from crude oil production. Additionally, in recent years, electric vehicles have been gaining market share, but the cost for electric vehicles is still more expensive than fossil fueled equivalents and limitations exist regarding cost, recharge time, and primary resources for battery and energy storage. Given the weight of batteries, electric long-haul trucking is also challenging, and most long-haul truck manufacturers are in search of affordable, low carbon options such as hydrogen-fueled trucking.

Natural hydrogen can be an answer to the low carbon, low cost, reliable transportation problem for long-haul trucking and potentially other forms of transportation. As for other types of transportation, natural hydrogen as a compressed or liquified product, or as a feedstock for synthetic liquid fuel (“efuels”), would be a reliable low cost, low carbon solution. Additionally, natural hydrogen could be combined with nitrogen to produce a carbon free ammonia product, which is being widely discussed as a potential replacement for bunker fuel for shipping.

Direct Emissions Reduction: Because there are no direct CO₂ emissions from the combustion or typical use of hydrogen, the reduction in CO₂ emissions is a function of what the hydrogen is replacing. In most cases, hydrogen is a substitute for natural gas, either in ammonia production, refining, as a feedstock for other chemicals, or in power generation.

In the case of ammonia production and refining, natural gas is used to produce hydrogen via steam methane reformation reactions, which is used as a chemical feedstock in both the refining process and the ammonia production process. Today, more than 95% of hydrogen is produced using natural gas in steam methane reformers (SMRs). The carbon intensity of hydrogen production using SMRs without carbon capture is 10.4 tonnes of CO₂ emitted for each tonne of hydrogen produced. As such, direct replacement of natural hydrogen for hydrogen manufactured by SMR processes results in a CO₂ reduction of 10.4 tonnes CO₂/tonne H₂.

In power generation with gas turbines, hydrogen must displace the energy (btu) equivalent of natural gas. The energy density of hydrogen is 290 btu/cf or 51,682 btu/lb. By comparison, the energy density of natural gas is 983 btu/cf or 20,267 btu/lb, while the carbon intensity of natural gas is 52.91 kg CO₂/mmbtu CH₄, 54.87 kg CO₂/mcf CH₄, or 3.5 kg CO₂/kg CH₄.

Because hydrogen is 2.6 times more energy dense per unit mass than natural gas, only 40% of the gross tonnage of fuel is required to achieve the same energy output. As such, burning one tonne of H₂ for power generation reduces natural gas consumption by about 2.6 tonnes, and thus CO₂ emissions by 9.1 tonnes.

Comparing natural hydrogen to hydrogen produced by electrolysis, the carbon reduction is a function of the carbon intensity of the power used in the electrolysis process. However, although there may be large indirect emissions associated with electrolysis, there are no direct emissions. Thus, natural hydrogen does not result in a direct emissions reduction as compared to electrolytically produced hydrogen.

Indirect Emissions Reduction: An analysis of the lifecycle carbon intensity of natural hydrogen using OPGEE has shown the lifecycle carbon intensity of natural hydrogen to be in the range of 0.1 to 0.4 tonnes CO₂/tonne H₂. Similar studies are not available for other methods of hydrogen production. However, using an average grid intensity of 0.5 tonnes CO₂/MWh, and given that electrolysis requires approximately 50 MWh/tonne H₂ produced, the indirect emissions associated with electrolysis are about 25 tonnes CO₂/tonne H₂ produced assuming grid power. Of course, electrolysis unit operators can purchase Renewable Energy Credits to synthetically reduce the carbon footprint of their power usage, but market recognition of this as a method for eliminating real time carbon emissions may not be permanent.

The realization of abundant natural hydrogen can achieve significant reductions in equivalent carbon emissions. An energy system that includes hydrogen can provide relatively low emissions and low costs coupled with a high reliability energy source. The benefits are included in both power generation and the transportation costs. In some embodiments, the hydrogen can be a natural source, either from a geothermal reservoir or other natural or synthetic hydrogen source.

It is noted that there is no requirement to provide or address the theory underlying the novel and groundbreaking production rates, performance or other beneficial features and properties that are the subject of, or associated with, embodiments of the present inventions. Nevertheless, various theories are provided in this specification to further advance the art in this important area, and in particular in the important area of hydrogen, dihydrogen sulfide, carbon dioxide, and helium exploration, production, and downstream conversion or utilization. These theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the conductivities, fractures, drainages, resource production, chemistries, and function-features of embodiments of the methods, articles, materials, devices, and system of the present inventions; and such later developed theories shall not limit the scope of protection afforded the present inventions.

The invention may be embodied in other forms than those specifically disclosed herein without departing from its spirit or essential characteristics. The described embodiments are to be considered in all respects only as illustrative and not restrictive. The various aspects and embodiments disclosed herein are for purposes of illustration and are not intended to be limiting. The various embodiments of devices, systems, activities, methods, and operations set forth in this specification may be used with, in or by, various processes, industries and operations, in addition to those embodiments of the Figures and disclosed in this specification. The various embodiments of devices, systems, methods, activities, and operations set forth in this specification may be used with: other processes industries and operations that may be developed in the future: with existing processes industries and operations, which may be modified, in-part, based on the teachings of this specification; and with other types of gas recovery and valorization systems and methods. Further, the various embodiments of devices, systems, activities, methods, and operations set forth in this specification may be used with each other in different and various combinations. Thus, for example, the configurations provided in the various embodiments of this specification may be used with each other. For example, the components of an embodiment having A, A′, and B and the components of an embodiment having A″, C, and D can be used with each other in various combination, e.g., A, C, D, and A. A″, C, and D, etc., in accordance with the teaching of this specification. Thus, the scope of protection afforded the present inventions should not be limited to a particular embodiment, configuration or arrangement that is set forth in a particular embodiment, example, or in an embodiment in a particular Figure.

Terms of degree (e.g., “about,” “substantially,” “generally,” etc.) indicate structurally or functionally insignificant variations. In an example, when the term of degree is included with a term indicating quantity, the term of degree is interpreted to mean±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. A method to provide a gas, the method comprising:
connecting a hydrogen storage reservoir to a gas production system;
injecting gas from the gas production system into the hydrogen storage reservoir; and
extracting the injected gas from the hydrogen storage reservoir.

2. The method of claim 1, wherein connecting a hydrogen storage reservoir to a gas production system includes making a fluid connection between the gas production system and the hydrogen storage reservoir with one or more of a well, a pipeline, or a pump.

3. The method of claim 1, wherein connecting a hydrogen storage reservoir to a gas production system includes connecting the hydrogen storage reservoir to an output of one or more of an electrolysis system, a pyrolysis system, or a reformer system configured to produce hydrogen.

4. The method of claim 1, wherein injecting gas from the gas production system into the hydrogen storage reservoir includes injecting hydrogen from one or more of an electrolysis system, a pyrolysis system, or a reformer system configured to produce hydrogen.

5. The method of claim 1, wherein injecting gas from the gas production system into the hydrogen storage reservoir includes injecting the gas into the hydrogen storage reservoir via an injection well.

6. The method of claim 1, wherein extracting the injected gas occurs after the hydrogen storage reservoir is depleted of natural hydrogen.

7. The method of claim 1, wherein extracting the injected gas occurs in parallel with depletion of natural hydrogen from the hydrogen storage reservoir.

8. The method of claim 1, wherein the hydrogen storage reservoir includes a subsurface geological formation that is depleted of natural hydrogen.

9. The method of claim 1, wherein the gas includes one or more of hydrogen, carbon dioxide, or helium.

10. The method of claim 9, further comprising supplying the extracted gas to one or more of an energy producer or a chemical producer, through a pipeline.

11. A method to provide hydrogen, the method comprising:
connecting a hydrogen storage reservoir to a hydrogen production system;
injecting hydrogen from the hydrogen production system into the hydrogen storage reservoir; and
extracting the injected hydrogen for energy production.

12. The method of claim 11, wherein connecting a hydrogen storage reservoir to a hydrogen production system includes connecting the hydrogen storage reservoir to an output of one or more of an electrolysis system, a pyrolysis system, or a reformer system configured to produce hydrogen.

13. The method of claim 11, wherein injecting hydrogen from the hydrogen production system into the hydrogen storage reservoir includes injecting hydrogen from one or more of an electrolysis system, a pyrolysis system, or a reformer system configured to produce hydrogen.

14. The method of claim 11, wherein extracting the injected hydrogen occurs after the hydrogen storage reservoir is depleted of natural hydrogen from the hydrogen storage reservoir.

15. The method of claim 11, wherein extracting the injected hydrogen occurs in parallel with depletion of natural hydrogen from the hydrogen storage reservoir.

16. The method of claim 11, wherein the hydrogen storage reservoir includes a subsurface geological formation that is depleted of natural hydrogen.

17. The method of claim 11, further comprising supplying the extracted hydrogen to one or more of an energy producer or a chemical producer.

18. A method to store carbon dioxide, the method comprising:
connecting a carbon dioxide source to a natural hydrogen reservoir, the carbon dioxide source being configured to capture carbon dioxide;
injecting captured carbon dioxide into the natural hydrogen reservoir; and
mineralizing the captured carbon dioxide within the natural hydrogen reservoir.

19. The method of claim 18, wherein the carbon dioxide source includes at least one of a steam methane reformer or an autothermal reformer.

20. A method to provide hydrogen, the method comprising:
injecting hydrogen from a hydrogen production system into a hydrogen storage reservoir including a subsurface geological formation that has been depleted of natural hydrogen; and
extracting the injected hydrogen for output to energy production, chemical synthesis, or as a feedstock.

21. A system to provide stored hydrogen, the system comprising:
a natural hydrogen storage reservoir;
a hydrogen production system; and
one or more conduits connecting the natural hydrogen storage reservoir to the hydrogen production system.

22. The system of claim 21, wherein the natural hydrogen storage reservoir includes a non-natural hydrogen therein.

23. The system of claim 21, wherein the hydrogen production system includes one or more of a reformer system, an electrolysis system, a pyrolysis system, or a plasma reformer.

24. A hydrogen storage reservoir, comprising:
a porous subsurface rock; and
an injection well configured to supply one or more of hydrogen gas, helium, or carbon dioxide gas to the porous subsurface rock, wherein the one or more of hydrogen gas, helium, or carbon dioxide gas is stored at or above hydrostatic pressure.

25. The hydrogen reservoir of claim 24, further comprising carbon dioxide within the porous subsurface rock, wherein the carbon dioxide is super critical.

26. The hydrogen reservoir of claim 24, further comprising a production well configured to remove the one or more of hydrogen gas, helium, or carbon dioxide gas from the porous subsurface rock.
